(19) United States
(12) Patent Application Publication
(10) Pub. No.: US 2026/0359229 A1
(43) Pub. Date: Nov. 12, 2026

(54) HIGHLY EFFECTIVE CACHE EVICTION POLICY

(71) Applicant: SAP SE, Walldorf (DE)

(72) Inventors: Kun Hu, Shanghai (CN); Na Zhang, Shanghai (CN); Fang Huang, Shanghai (CN); Yijin Hu, Shanghai (CN); Jun Tu, Shanghai (CN); Weijun Yu, Shanghai (CN); You Li, Shanghai (CN)

(21) Appl. No.: 19/204,903

(22) Filed: May 12, 2025

(51) Int. Cl. G06F 12/121

(52) U.S. Cl. CPC G06F 12/121; G06F 2212/1016

(57) ABSTRACT

In some implementations, there is provided a method including receiving a first identifier of a first target population data set; checking, based on the first identifier, whether the first target population data set is stored in a cache; in response to the first target population data set not being stored in the cache, determining a first size for the first target population data set, determining a first hit count for the first target population data set, and determining a first weight for the first target population data set, wherein the first weight is calculated based at least on the first hit count and the first size for the first target population data set. Related systems, methods, and articles of manufacture are also disclosed.

### TECHNICAL FIELD

The present disclosure generally relates to managing cache evictions in a database system.

### BACKGROUND

Organizations increasingly need to manage large amounts of data in their database systems. Running queries on such database systems can use a significant amount of computing resources, including computer memory, storage, and processor resources. To that end, query results (including partial results) may be cached, so they can be used later. For example, caching query results can save computing resources at the cost of increased memory consumption. When a subsequent query is received, the cached query results can be reused.

### SUMMARY

In some implementations, there is provided a method including receiving a first identifier of a first target population data set; checking, based on the first identifier, whether the first target population data set is stored in a cache; in response to the first target population data set not being stored in the cache, determining a first size for the first target population data set, determining a first hit count for the first target population data set, and determining a first weight for the first target population data set, wherein the first weight is calculated based at least on the first hit count and the first size for the first target population data set; determining a second target population data set to evict from the cache to generate space to store the first target population data set, wherein the determining the second target population data set to evict is based at least on a second weight associated with the second target population data set; evicting the second target population data set from the cache; and storing the first target population data set in the cache.

One or more of the following features may also be provided. In response to the first target population data set being stored in the cache, increasing the hit count and getting, from the cache, the first target population data set to enable filtering query results. The first identifier may include an access user, a permission, and a target population identifier. The checking may further include using the first identifier as an entry key into the cache. The first hit count may be determined from a global counter for the first target population data set. The global counter may be reset at a predetermined time. The first weight for the first target population data set may be determined by combining the first hit count and the first size for the first target population data set. The first hit count and the first size may be smoothed using a logarithmic function before the combining which comprises a sum. In response to the first hit count being over a threshold, the first hit count may be set to a value of 1, and wherein in response to the first hit count being less than the threshold, the first hit count may be set to a value of 0. The combined first hit count and the first size are rounded to a nearest integer. The first size for the target population data set may be scaled by a weight factor.

Non-transitory computer-readable storage medium (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a block diagram of an example of a database system, in accordance with some example implementations of the current subject matter;

FIG. 2 illustrates another block diagram of an example of a database system, in accordance with some example implementations of the current subject matter;

FIG. 3A illustrates an example of a process for cache eviction, in accordance with some example implementations of the current subject matter;

FIG. 3B illustrates an example of an entry key mapped to cache, in accordance with some example implementations of the current subject matter;

FIG. 4 illustrates a block diagram showing weight calculation for cache eviction, in accordance with some example implementations of the current subject matter;

FIG. 5 depicts an example of a system, in accordance with some example implementations of the current subject matter; and

FIG. 6 depicts another example of a system, in accordance with some example implementations of the current subject matter.

### DETAILED DESCRIPTION

Cache, as noted, may be used by systems, such as database management systems, enterprise resource system, and/or the like. The use of cache in these types of systems can increase performance, so that future requests for data can be served faster, decreased transaction speed to perform a query can be realized, reduced time associated with reading from persistent store can be realized, and/or the like. As data items may be repetitively accessed for requests, caching the data (and/or its data structure) may thus accelerate data retrieval and processing, but the cache's data content may need to be managed using cache eviction. In the case of a database query of a database for example, the cache may store certain query results, so that these results can be quickly re-used.

The phrase “cache eviction” refers to removing certain data from a cache. The eviction frees up room in the cache (also referred to as cache memory) as the cache reaches a capacity or size limit of the cache. A cache eviction policy may for example evict, based on time in the cache, data from the cache. This eviction policy is referred to as a least recently used (LRU) cache eviction policy, where a cached data item (which has not been used for a threshold amount of time) is evicted. The cache eviction policy may also be based on frequency of use. This is referred to a least frequently used (LFU) eviction, where for example a cached data item (which has been accessed less than a given number of times or frequency) may be evicted from the cache. The cache eviction policy may be based on a random eviction scheme, in which case a cached data item is randomly selected from the cache for eviction. Moreover, the cache eviction may also be based on a time-to-live value, in which case a cached data item is evicted when the cached data item exceeds a certain time in the cache.

The above-noted cache eviction strategies may, however, focus on a limited set of factors, while neglecting the impact of a specific size of a cache entry on the cache eviction policy's overall efficiency.

In scenarios related to authorization for example, a database query from a specific user may return only the results to which the specific user is authorized (e.g., has permission to view or obtain the results of the database query). To illustrate further, a user, such as a senior manager, may query a database for payroll files of employees reporting to the senior manager. The query may be received for query execution at a database system that includes not only the payroll files of the senior manager's employees, but the query may implicate other data (e.g., associated with other employees that do not report to the manager or even other types of data such as company financial data) that the senior manager does not have the permission or authorization to access. In some instances, the query may be associated with or map to a key (e.g., an entry key). For example, if the query is for payroll data of the senior manager's direct reports, the entry key may include the senior manager's user ID and a permission, such as an indication of the manager's authorization to view (or, e.g., perform another action, such as write, etc.) at least one group of data. The database system may process the query by filtering the query results, so that only the results that the senior manager is authorized (or has permission) to receive are provided to the senior manager.

By way of a numerical example, the query result set (which the senior manager has permission to access) may represent a “target population” of 1000 records corresponding to the payroll files of 1000 employees reporting to the senior manager. This target population data set (e.g., 1000 payroll file records) may be put into a cache as a data structure that can be accessed with a key, such as the entry key. Alternatively, or additionally, the identities (IDs) of the 1000 employees (which the senior manager has permission to for example view) may also be put into cache as a data structure that can be accessed with the entry key. The 1000 records all may be related to the senior manager or, alternatively, the 1000 records may be responsive to the query such that only a subset of the 1000 records are accessible by the senior manager.

In the previous example, the database query may potentially lead to a substantial computational load due to complex rules and the large-scale size of the target population, such as the 1000 records noted in the previous example. To illustrate further, if the user is a human resources head, the target population associated with a database query may be thousands if not tens of millions of employees, so each time the user's authorization is accessed for a query execution, a local caching mechanism can be used for the target population's data set, such as the payroll files for the thousands or even millions of employees, for example. The database query calculation cost and memory usage may be influenced by the size of the target population data set, such that a larger and frequently accessed target population data set is preferred to remain (e.g., have increased residency time) in the cache, when compared to smaller and/or infrequently used cached data.

In some embodiments, there is provided a novel cache eviction policy that is based on hit count and cache entry size to enable more effective management of cache resources. This novel cache eviction policy may provide improved database system performance.

In some embodiments, the cache eviction is a weight-based cache eviction policy, wherein the weight assigned to a cache's data entry of a target population dataset is based on hit count and size of the data entry in the cache. The phrase “hit count” indicates a quantity of times a data entry in the cache is accessed (which may be over a period of time), so the hit count may represent access frequency over a given period of time. The hit count may be implemented as a global counter that records a count for each cache entry key, wherein the cache entry key is a key that maps to the cache's data entries that are stored in the cache's memory. In other words, the data stored in cache is accessed using the entry key, so tracking access to the entry key also indicates access to the data stored in cache. The cache's entry size is determined (e.g., calculated) before the data is entered or inserted into the cache. And when the cache entry is performed, a weight associated with the cache entry may also be updated.

Before providing additional examples with respect to the weight-based cache eviction policy, the following provides an example of a system environment in which the disclosed weight-based cache eviction policy may be practiced.

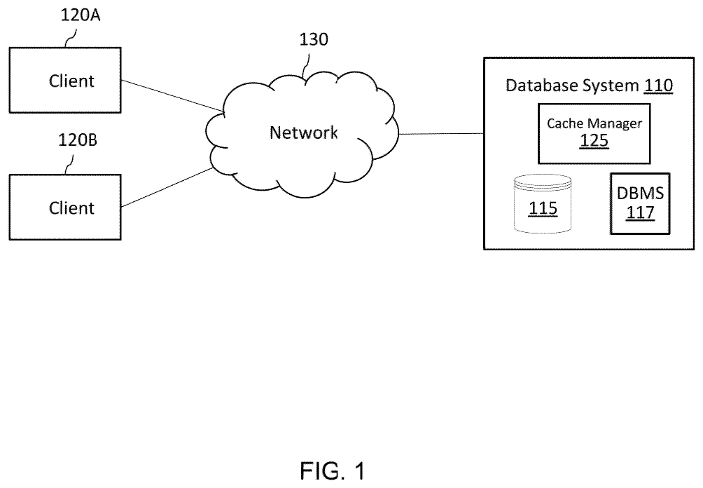

FIG. 1 illustrates an example of a database system 110, in accordance with some embodiments. The database system 110 may include any number and type of databases 115 including, for example, an in-memory database, a relational database, a non-SQL (NoSQL) database, a graph database, and/or other types of databases. In an example, the database 115 may be an SAP HANA database as available from SAP SE, Walldorf, Germany, although as noted other types of databases may be used as well. The database system may also include a database management system (DBMS) 117. The database management system may be configured to process database queries from one or more client devices, such as a first client 120A and/or a second client 120B. The database system 110 may also include at least one cache manager 125, which may be configured to at least perform cache eviction, in accordance with some embodiments.

In some implementations, the database system 110 and/or any of its components may be incorporated and/or part of a container system that may be used in cloud-based implementations. The database system 110 may include any number of servers and other physical components. Furthermore, the database system 110 may be communicatively coupled, via a network 130, to a plurality of clients including, for example, the first client 120A and the second client 120B. The network 130 may be a wired and/or wireless network including, for example, a wide area network (WAN), a local area network (LAN), a public land mobile network (PLMN), the Internet, and/or the like. The client devices may be processor-based devices including, for example, one or more of a smartphone, a tablet computer, a wearable apparatus, a virtual assistant, an Internet-of-Things (IoT) appliance, and/or the like.

As noted, the database system 110 may include any number of servers which may be running instances of the corresponding executables (e.g., .exe files) included in a kernel of the database system 110. It should be appreciated that the kernel of the database system 110 may also include other executable (e.g., .exe files) required for running the database system 110. In some implementations, an executable may be a computer program that has already been compiled into machine language (e.g., binary code) and is therefore capable of being executed directly by a data processor. In an example, the database system 110 may be a dedicated, single-container database system running a single instance of a primary server and/or a secondary server. However, where the database system 110 implements a multitenant database architecture (e.g., multitenant database containers (MDC)), each tenant of the database system 110 may be served by separate instances of the primary server and/or the secondary server.

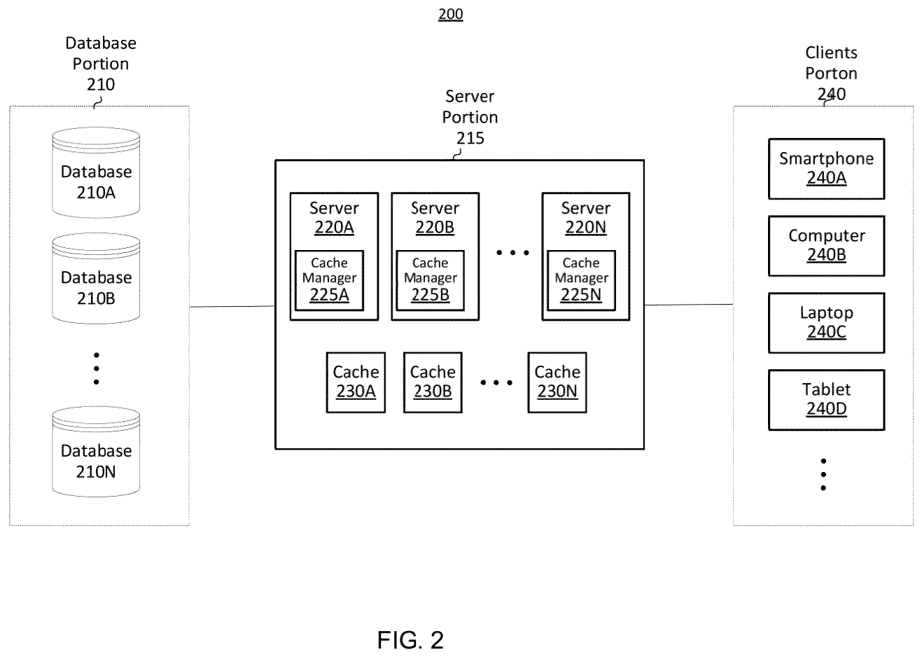

Turning now to FIG. 2, an example of a database system 200 is shown, in accordance with some example embodiments. The database system 200 is similar in some respect to the database system 110 depicted at FIG. 1, but the database system 200 provides additional details with respect to the cache.

In the example of FIG. 2, the database system 200 includes a database portion 210, a server portion 215, and/or a client portion 240. The database portion 210 includes any number and type of databases 210A-210N. The databases 210A, 210B, and 210N may include any combination of one or more of a relational database, a multi-dimensional database, an in-memory facility, an object database, an Extensible Markup Language (XML) document, flat files, or any other data storage system that supports structured or unstructured data. The databases 210A-N may be distributed among several different entities.

The server portion 215 may include servers 220A-N, which may be any type of servers, such as index servers, primary servers, secondary servers, and so on. The servers 220A-N can include any combination of one or more of cloud-based or on-premises resources and may be exposed (and/or accessed) via one or more networks.

Each server 220A-N may include or be associated with one or more corresponding cache managers 225A-N. For example, the server 220A may include the cache manager 225A, server 220B may include the cache manager 225B, and server 220N may include the cache manager 225N. The cache managers 225A-N are configured to manage the actual caches, such as the caches 230A, 230B, and 230N. In some embodiments, the cache managers 230A-N handle the cache eviction policy of a corresponding cache 230A-N.

The client portion 240 may include any number and type of client devices including a smartphone 240A, a computer 240B, a laptop 240C, a tablet 240D, and other computing devices and/or computing systems. In this way, a query from a client portion 240 is transmitted by server portion 215 to database portion 210. Database portion generates a response that is sent back to server portion 215. Server portion 215 returns all or a portion of the response generated by the originating query to the client portion 240 and stores the response in the associated cache 230A-N. In this way, responses to subsequent queries related to the initial query can be generated using data stored in one of the caches 230A-N without the need for the server portion 215 to issue a query to database portion 210.

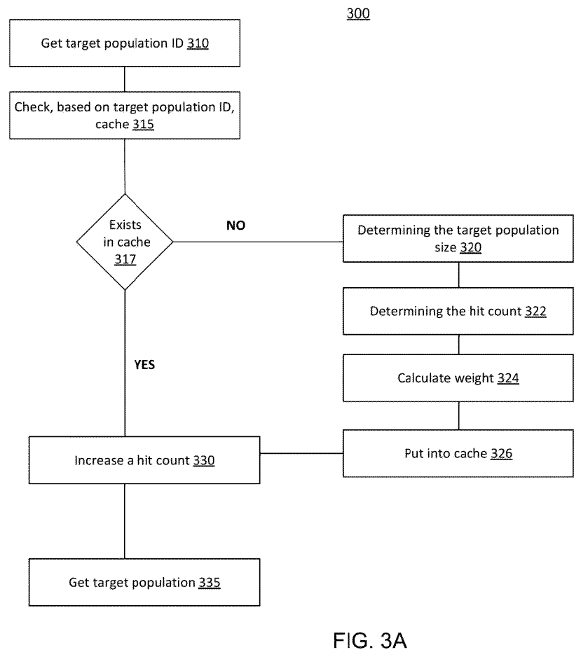

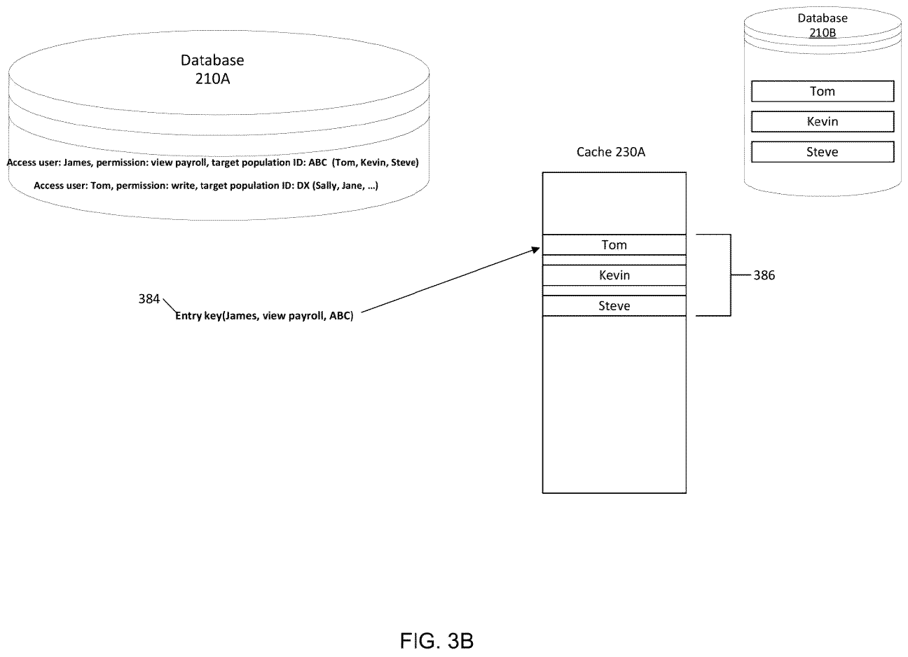

FIG. 3A depicts an example of a computer-implemented process 300 for weight-based cache eviction, in accordance with some embodiments. In some embodiments, each data entry in the cache represents a data entry for a target population (“target population data entry”). A weight is assigned to the target population data entry and/or the entry key (e.g., a hash, a key entry, and/or the like) that is mapped to the data stored in the cache. The weight is used to determine whether to evict the target population data entry from the cache. If, for example, the weight is below a threshold value, the cache's data entry is evicted from cache but if the weight is above a threshold value, the cache's data entry is not evicted from cache.

At 310, the process 300 may include getting a target population identifier (ID). In some embodiments, the target population ID may be obtained from a database, such as database 210A, that stores role-based authorizations.

The following is an example used to illustrate the target population ID. A database query may be received by the database system 200. When this is the case, the database query may be for a query of payroll data for the employees directly reporting to a manager, such as James. In this example, the manager James has a role-based authorization (or permission) configured in the database system. This role-based authorization may indicate the accessing user (which in this example is James), the permission (which in this example is view payroll data and implies an importance to the data query based on either permission (e.g., an HR employee may write into a record, but a manager only can read a record and thus the HR employee's permission should give her more importance to her query than the manager's)), and one or more target population IDs that show a link or association with the accessing user (e.g., link ABC). The target population ID indicates (e.g., maps to, defines, represents, and/or the like) a set of usernames (or user IDs), such as the set of employees reporting to James (e.g., employees are linked to their respective managers). In this example, Tom, Kevin, and Steven are the target population set identified by the target population ID ABC. As shown in FIG. 3B, the role-based authorization may be stored in a database, such as the database 210A, along with other roles-based authorization for other users. It should be noted that the target population ID can be based on any relationship such as employee/manager but it can also be just the fact that the access user has requested that data (e.g., requestor/results). In such circumstances when the results include data to which the access user does not have permission, the filtering operation may be needed to provide only that data to which the access user does have permission.

The triplet of access user, permission, and target ID may be used as an entry key 384 into the cache 230A as depicted at FIG. 3B. For example, James, view payroll, and ABC may be used as an entry key into the cache 230A. To illustrate further, James, view payroll, and ABC may be mapped into one or more locations in the cache 230A where the cache entry 386 for Tom, Kevin, and Steve are stored. When the query of payroll data for the employees directly reporting to manager James is received by the database system, the cached names may be used to filter query results so that only the results for the target population ID set of Tom, Kevin, and Steve are returned to manager James. It should be noted that manager James may issue multiple queries such that more than one population target data set will have one or two parts of the triple the same, yet with a different target ID. Following the above example, James (access user) may issue a query or instruction to write payroll (e.g., approve vacation time) for one employee (e.g., Steve; which yields different link of XYZ). Despite the common fields, this will still generate a different entry key and thus a different target population data in cache.

Although this example shows an example with only 3 cache entries, the cache entries may be larger or smaller as well (e.g., 1000 employee names or other quantities as well). In addition, the cache entries may encompass more than those responsive to the query to which the access user has permission (e.g. cache entry 386 could include more than the 3 cache entries shown in FIG. 3B).

At 315, the process 300 may include checking, based on the target population ID, a cache. For example, the cache manager 225A may check the cache 230A to determine whether the cache 230A includes the data entry associated with the target population ID. Referring to the previous example and FIG. 3B, the triplet of James, view payroll, and ABC may be used as an entry key 384 into the cache 230A where the target population ID entries of Tom, Kevin, and Steve might be located. Alternatively, or additionally, the filtered payroll files for Tom, Kevin, and Steve may also be in the cache 230A (or stored in another cache or a persistent store outside of cache).

In response to the cache check at 315 revealing the target population ID (or its associated data entry) is in the cache such as the cache 230A, the process 300 may further include increasing the hit count (yes at 317 and 330). For example, the cache manager 225A may determine that the cache 230A does include the data entry, such as the payroll records for the 1000 employees, the cache manager 225A may increment (or cause to be incremented) a counter, such as a global counter 410.

At 335, the process 300 may include getting from cache the target population data set. For example, the target population data set (e.g., the entry in cache for the data entry 386 for Tom, Kevin, and Steve) may be retrieved from a cache, such as cache 230A, so the data entry can be used by a server 220A for database query execution (e.g., to enable filtering query results). As there is a cache hit, the cache manager may increase a cache hit count at the global counter 410 for the data entry 386 in cache.

In response to the check at 315 revealing the target population ID (or its associated data entry) is not in the cache such as the cache 230A (no at 317), the process 300 may include determining, at 320, the target population size (e.g., the quantity of entries at the data entry 386), determining, at 322, the hit count (e.g., based on the global counter value), determining, at 324, the weight, and putting, at 326, the target population data (e.g., 3 or more data entry 386 records) into cache, such as cache 230A. After the target population is inserted or put, at 326 into the cache, the process may return to 330.

The calculated weight may be used in deciding whether to evict the target population data set stored in cache. For example, if the calculated weight is below a threshold value, the target population data set, such as entry 386 at FIG. 3B, is evicted from, cache 230A. But if the calculated weight is above a threshold value, the target population data set, such as entry 386 at FIG. 3B, is not evicted from the cache.

Referring again to 320, since the target population data set is not in the cache, the target population data set is obtained by querying a database, such as database 210A, for the target population data set entries. At this point, the cache manager 225A can determine the size of the target population data set based on for example the number of entries, rows, or records returned by the database 210A. The target population size may indicate 3 (e.g., Tom, Kevin, Steve) or an alternative number (e.g., 1000) depending on how the database 210A is instructed to return results. The target population size can be provided by database 210A when it returns the data set to server 220A (e.g., as part of header data) and stored with the target population data or the cache 230A can calculate the target population size by mathematical operations (e.g., subtracting) of memory addresses, or some other method.

Referring again to 322, the cache manager 225A may determine the hit count for the target population. The hit count may be determined by reading the hit count from memory. Alternatively, the hit count may be determined by calculating a frequency or recency of access of the target population data set in cache. For example, the cache entry 386 of Tom, Kevin, and Steve for the entry key 384 of “James, view payroll, ABC” may be added into the cache 230A at 9:00 AM for the first time, so the hit counter in this case is 0. From 9:00AM to 9:30AM, this cache entry 386 is hit 10,000 times (so the counter value will be 10,000) and the entry key 384 “James, view payroll, ABC” (which points to Tom, Kevin, Steven) is removed from the cache 230A due to a cache eviction. At 10:00 AM however, another cache query uses the entry key 384 “James, view payroll, ABC” but there is no entry in the cache as it was evicted. As such, the cache entry of Tom, Kevin, Steven is re-inserted into the cache 230A and a weight calculation is performed for the entry key James, view payroll, ABC's counter (which is for example 10,000 or alternatively an indication of time can be used along with the raw hit count for example, 10,000 hits divided by 60 minutes would yield a hit count of 167, etc.). At 10:00 AM, the entry key James, view payroll, ABC will get a higher weight (when compared to the 9:00 AM example above) and thus should be less likely to be removed as part of cache eviction.

Referring again to the weight calculation at 324, a data entry in cache may be evicted based on a weight assigned to the cache entry. For example, a weight value that exceeds a threshold value indicates that the corresponding data entry in cache is not to be evicted from the cache (i.e., not be evicted), while a weight below a threshold value indicates that the corresponding data entry in the cache is (or will be) evicted from the cache. Alternatively, or additionally, the determined weight value itself may be used to rank which cache entries to evict, so for example a lower weight value is evicted before a higher weight value (or vice versa). To illustrate further, the lowest weight value of all cache data entries is evicted (or vice versa where the highest weight value is evicted).

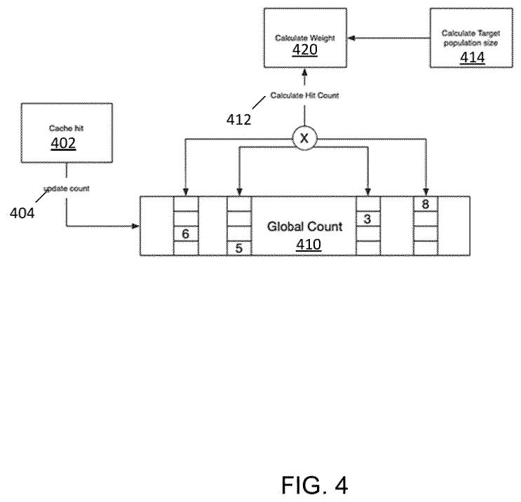

FIG. 4 depicts a block diagram depicting an example of a weight calculation (see, e.g., FIG. 3A at 324) for cache eviction, in accordance with some embodiments. In the example of FIG. 4, a global counter 410 is maintained for each entry key, such as entry key 384, for the cache, such as the cache 230A and the like. Alternatively, or additionally, a single global counter may be used (e.g., using a two-dimensional array or Count-Min Sketch algorithm). The count at the global counter 410 provides an indication of the access frequency of each cache entry, wherein the global counter is incremented by a value of one each time the corresponding cache entry key is accessed. In some embodiments, the global cache is reset to a predetermined value, such as zero, from time to time (e.g., daily or other times as well such as hourly, weekly, etc.) so the count may also indicate frequency of a corresponding time period. When a cache hit 402 occurs for an entry key 384 of the cache 230A, this causes an update count 404 for that entry key, such that an indication to update 404 is provided to the global counter 410. The global counter 410 outputs a hit count 412 for a corresponding entry key. The hit count 412 and an entry size (labeled target population size 414) of the cache entries, such as 3 for the entries 386, are combined (e.g., summed, multiplied, or the use of some other mathematical operation) to provide a weight 420 (e.g., an eviction weight) for the entry key, so the eviction weight can be used to determine whether (or not) to evict the entry key's data entries that are in the cache 230A.

The global counter 410 may comprise a two-dimensional array (e.g., using Count-Min Sketch) of w columns and d rows for example, such that when a hit count is increased for an entry key, the column applies a hash function to obtain an index that points to a cache entry (e.g., a row and a column location in the array) for the increase in the hit count.

In some embodiments, the weight of an entry key for the cache entry may be determined based on hit count (e.g., hit count 412) and entry size (e.g., target population size 414).

In some embodiments, the weight of an entry key may be determined, at 420, by the entry key's hit count 412 (which may be obtained from the global counter 410) and the entry size (which may be determined at 320). For example, the hit count and entry size may be combined using various mathematical operations (e.g., summed, added, multiplied, logarithms, etc.) to provide the weight. As noted, the weight may be assigned to the entry key, such as entry key 384, and/or the corresponding data entry 386.

In some embodiments, the weight may be calculated according to the hit count and the entry size as follows:

Weight=ceil((log(hit_count)×H(hit_count−threshold))+ceil(log(entry_size)×W(entry_key)),

wherein
the log(hit_count) is a logarithm of the hit count (wherein the logarithm smooths the hit count);
the H(hit_count−threshold) is a Heaviside (H) step function (although other types of step function may be used) that has a value of 1 when the hit count is over a threshold hit count value and 0 when the hit count is below the threshold hit count value;
the log(entry_size) is a logarithm of the cache entry's size, such as the size of the target population (wherein the logarithm smooths the value of the entry size);
the W(entry_key) is a statistical or weight factor which may be used to adjust the weight or impact of the entry size;
the “+” symbol represents a sum or addition of the two logarithmic values (which combines the effects of both factors); and
the ceil( ) operation rounds up the result to the nearest integer (which ensures the weight is always a positive integer).

The log of the entry size may normalize or smooth the size values and give more weight to smaller sized entries. By way of explanation, one cache entry that is 10 times the size of another cache entry would be favored to avoid eviction by a factor of 10 based on this factor alone and this could in turn substantially reduce the role the hit count variable plays in this method such that the larger cache entry could, in theory, never be evicted assuming the larger cache entry has a non-zero hit count over that period of time.

In similar fashion, the log of the hit count provides a smoothing that reduces the impact of extreme values and gives more weight to smaller hit values. By way of example, a larger cache entry with a substantially lower hit count could be evicted earlier than optimal over a smaller cache entry with a higher hit count and thus incur the costs of moving more data into and out of the cache then is necessary.

The threshold used in the Heaviside step function may have a predetermined threshold. Alternatively, or additionally, the predetermined threshold may be determined dynamically based on statistics of hit counts (e.g., as a function of 1, 2, 3, or more standard deviations from a mean of the hit counts contained in the global counter 410). In this way, the changing of the threshold can help offset disparities between data entries with wide ranging entry sizes (e.g., decreasing the threshold balances out the impacts of the varied entry sizes).

The W(entry-key) may be a statistical or weight factor calculated based on an analysis of the entry key into the cache. For example, the weight or statistical factor may be used to scale or adjust the importance of the entry size. Referring to earlier examples, an HR employee (access user) with permission to write into certain records (permission) impacting a large pool (target ID), this could occur when cost of living increases are applied to all employee wages, is a more important operation and should get greater weight over other types of transactions. It should be noted that not all of the parts of the entry key need to be used in determining the W(entry_key). To illustrate further, permission may be a part of the entry key, and permission may also comprise groups which have different priorities, such that high priority means high weight. In the case of for example an employee center, if a user's permission's group belongs to employee center, the W(entry_key) will be a higher weight. This mapping (permission group to priority) may be stored in memory and can be accessed when calculating the weight.

While the addition operator is used in the equation above, other mathematical operators may be used to combine a hit count parameter with an entry size parameter. One such operator is the multiplication operator, but others are contemplated by this invention.

Finally, as noted earlier, the hit count in some implementations may have a memory feature (e.g., data entry stored into cache at 9:00 am, is evicted at 9:30 am after registering 10,000 hit counts and is then rewritten into the cache at 10:00 am begins with a hit count of 10,000 as opposed to 0). In some circumstances, this functionality could cause the hit count for that cache entry to become too large to be evicted even though it would be a better candidate for eviction over a large, less frequently hit cache entry. To compensate for this skewing, each data entry would have its hit count reset to 0 after a certain amount of time (e.g., 24 hours). Individual entries could be reset once every time period such that the group of cache entries would have a staggered reset period or the entire cache could be reset once in a period (e.g., every day at 12:01 am).

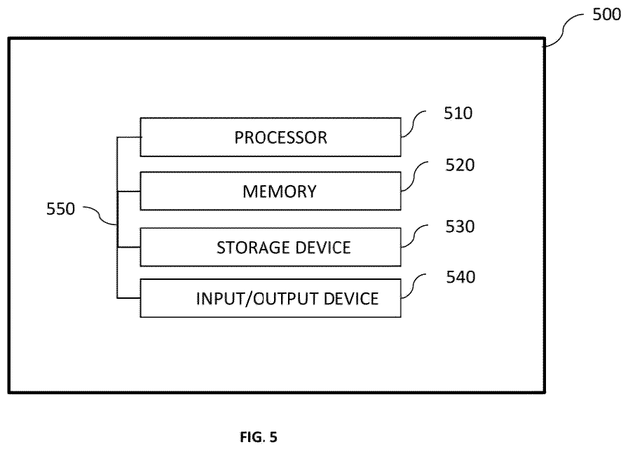

In some implementations, the current subject matter may be configured to be implemented in a system 500, as shown in FIG. 5. The system 500 may include a processor 510, a memory 520, a storage device 530, and an input/output device 540. Each of the components (e.g., processor 510, memory 520, storage device 530, and input/output device 540) may be interconnected using a system bus 550. The processor 510 may be configured to process instructions for execution within the system 500. In some implementations, the processor 510 may be a single-threaded processor. In alternate implementations, the processor 510 may be a multi-threaded processor. The processor 510 may be further configured to process instructions stored in the memory 520 or on the storage device 530, including receiving or sending information through the input/output device 540. The memory 520 may store information within the system 500. In some implementations, the memory 520 may be a computer-readable medium. In alternate implementations, the memory 520 may be a volatile memory unit. In yet some implementations, the memory 520 may be a non-volatile memory unit. The storage device 530 may be capable of providing mass storage for the system 500. In some implementations, the storage device 530 may be a computer-readable medium. In alternate implementations, the storage device 530 may be a floppy disk device, a hard disk device, an optical disk device, a tape device, non-volatile solid state memory, or any other type of storage device. The input/output device 540 may be configured to provide input/output operations for the system 500. In some implementations, the input/output device 540 may include a keyboard and/or pointing device. In alternate implementations, the input/output device 540 may include a display unit for displaying graphical user interfaces.

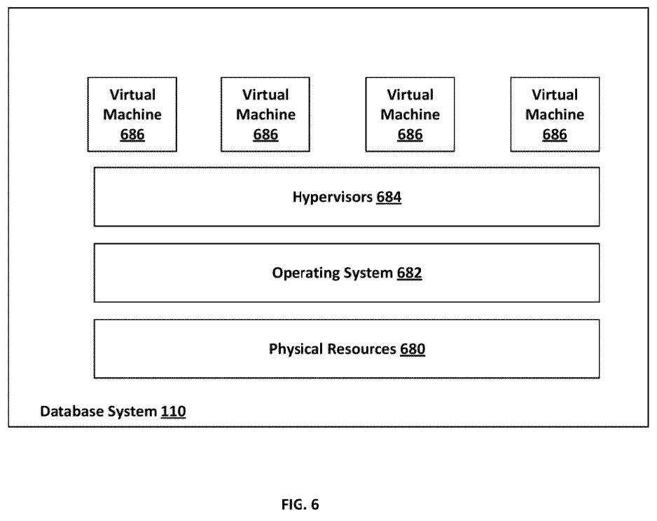

FIG. 6 depicts an example implementation of the database system 110 (of FIG. 1). The database system 110 may be implemented using various physical resources 680, such as at least one or more hardware servers, at least one storage, at least one memory, at least one network interface, and the like. The database system 110 may also be implemented using infrastructure, as noted above, which may include at least one operating system 682 for the physical resources 680 and at least one hypervisor 684 (which may create and run at least one virtual machine 686). For example, each multitenant application may be run on a corresponding virtual machine 686.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:
Example 1. A computer-implemented method comprising:
   receiving a first identifier of a first target population data set;
   checking, based on the first identifier, whether the first target population data set is stored in a cache;
   in response to the first target population data set not being stored in the cache, determining a first size for the first target population data set, determining a first hit count for the first target population data set, and determining a first weight for the first target population data set,
wherein the first weight is calculated based at least on the first hit count and the first size for the first target population data set;
   determining a second target population data set to evict from the cache to generate space to store the first target population data set, wherein the determining the second target population data set to evict is based at least on a second weight associated with the second target population data set;
   evicting the second target population data set from the cache; and
   storing the first target population data set in the cache.
Example 2. The computer-implemented method of Example 1 further comprising:
   in response to the first target population data set being stored in the cache, increasing the hit count; and
   getting, from the cache, the first target population data set to enable filtering query results.
Example 3. The computer-implemented method of any of Examples 1-2, wherein the first identifier comprises an access user, a permission, and a target population identifier.
Example 4. The computer-implemented method of any of Examples 1-3, wherein the checking further comprises using the first identifier as an entry key into the cache.
Example 5. The computer-implemented method of any of Examples 1-4, wherein the first hit count is determined from a global counter for the first target population data set, and wherein the global counter is reset at a predetermined time.
Example 6. The computer-implemented method of any of Examples 1-5, wherein the first weight for the first target population data set is determined by combining the first hit count and the first size for the first target population data set.
Example 7. The computer-implemented method of any of Examples 1-6, wherein the first hit count and the first size are smoothed using a logarithmic function before the combining which comprises a sum.
Example 8. The computer-implemented method of any of Examples 1-7, wherein in response to the first hit count being over a threshold, the first hit count is set to a value of 1, and wherein in response to the first hit count being less than the threshold, the first hit count is set to a value of 0.
Example 9. The computer-implemented method of any of Examples 1-8, wherein the combined first hit count and the first size are rounded to a nearest integer.
Example 10. The computer-implemented method of any of Examples 1-9, wherein the first size for the target population data set is scaled by a weight factor.
Example 11. A system comprising:
   at least one processor; and
   at least one memory including instructions which when executed by the at least one processor causes operations comprising:
      receiving a first identifier of a first target population data set;
      checking, based on the first identifier, whether the first target population data set is stored in a cache;
      in response to the first target population data set not being stored in the cache, determining a first size for the first target population data set, determining a first hit count for the first target population data set, and determining a first weight for the first target population data set,
      wherein the first weight is calculated based at least on the first hit count and the first size for the first target population data set;
      determining a second target population data set to evict from the cache to generate space to store the first target population data set, wherein the determining the second target population data set to evict is based at least on a second weight associated with the second target population data set;
      evicting the second target population data set from the cache; and
      storing the first target population data set in the cache.
Example 12. The system of Example 11 further comprising:
   in response to the first target population data set being stored in the cache, increasing the hit count; and
   getting, from the cache, the first target population data set to enable filtering query results.
Example 13. The system of any of Examples 11-12, wherein the first identifier comprises an access user, a permission, and a target population identifier.
Example 14. The system of any of Examples 11-13, wherein the checking further comprises using the first identifier as an entry key into the cache.
Example 15. The system of any of Examples 11-14, wherein the first hit count is determined from a global counter for the first target population data set, and wherein the global counter is reset at a predetermined time.
Example 16. The system of any of Examples 11-15, wherein the first weight for the first target population data set is determined by combining the first hit count and the first size for the first target population data set.
Example 17. The system of any of Examples 11-16, wherein the first hit count and the first size are smoothed using a logarithmic function before the combining which comprises a sum.
Example 18. The system of any of Examples 11-17, wherein in response to the first hit count being over a threshold, the first hit count is set to a value of 1, and wherein in response to the first hit count being less than the threshold, the first hit count is set to a value of 0.
Example 19. The system of any of Examples 11-18, wherein the combined first hit count and the first size are rounded to a nearest integer.
Example 20. A non-transitory computer-readable storage medium instructions which when executed by at least one processor causes operations comprising:
   receiving a first identifier of a first target population data set;
   checking, based on the first identifier, whether the first target population data set is stored in a cache;
   in response to the first target population data set not being stored in the cache, determining a first size for the first target population data set, determining a first hit count for the first target population data set, and determining a first weight for the first target population data set,
wherein the first weight is calculated based at least on the first hit count and the first size for the first target population data set;
   determining a second target population data set to evict from the cache to generate space to store the first target population data set, wherein the determining the second target population data set to evict is based at least on a second weight associated with the second target population data set;
   evicting the second target population data set from the cache; and
   storing the first target population data set in the cache.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method comprising:
receiving a first identifier of a first target population data set;
checking, based on the first identifier, whether the first target population data set is stored in a cache;
in response to the first target population data set not being stored in the cache, determining a first size for the first target population data set, determining a first hit count for the first target population data set, and determining a first weight for the first target population data set,
wherein the first weight is calculated based at least on the first hit count and the first size for the first target population data set;
determining a second target population data set to evict from the cache to generate space to store the first target population data set, wherein the determining the second target population data set to evict is based at least on a second weight associated with the second target population data set;
evicting the second target population data set from the cache; and
storing the first target population data set in the cache.

2. The computer-implemented method of claim 1 further comprising:
in response to the first target population data set being stored in the cache, increasing the hit count; and
getting, from the cache, the first target population data set to enable filtering query results.

3. The computer-implemented method of claim 1, wherein the first identifier comprises an access user, a permission, and a target population identifier.

4. The computer-implemented method of claim 3, wherein the checking further comprises using the first identifier as an entry key into the cache.

5. The computer-implemented method of claim 1, wherein the first hit count is determined from a global counter for the first target population data set, and wherein the global counter is reset at a predetermined time.

6. The computer-implemented method of claim 1, wherein the first weight for the first target population data set is determined by combining the first hit count and the first size for the first target population data set.

7. The computer-implemented method of claim 6, wherein the first hit count and the first size are smoothed using a logarithmic function before the combining which comprises a sum.

8. The computer-implemented method of claim 6, wherein in response to the first hit count being over a threshold, the first hit count is set to a value of 1, and wherein in response to the first hit count being less than the threshold, the first hit count is set to a value of 0.

9. The computer-implemented method of claim 6, wherein the combined first hit count and the first size are rounded to a nearest integer.

10. The computer-implemented method of claim 6, wherein the first size for the target population data set is scaled by a weight factor.

11. A system comprising:
at least one processor; and
at least one memory including instructions which when executed by the at least one processor causes operations comprising:
receiving a first identifier of a first target population data set;
checking, based on the first identifier, whether the first target population data set is stored in a cache;
in response to the first target population data set not being stored in the cache, determining a first size for the first target population data set, determining a first hit count for the first target population data set, and determining a first weight for the first target population data set,
wherein the first weight is calculated based at least on the first hit count and the first size for the first target population data set;
determining a second target population data set to evict from the cache to generate space to store the first target population data set, wherein the determining the second target population data set to evict is based at least on a second weight associated with the second target population data set;
evicting the second target population data set from the cache; and
storing the first target population data set in the cache.

12. The system of claim 11 further comprising:
in response to the first target population data set being stored in the cache, increasing the hit count; and
getting, from the cache, the first target population data set to enable filtering query results.

13. The system of claim 11, wherein the first identifier comprises an access user, a permission, and a target population identifier.

14. The system of claim 13, wherein the checking further comprises using the first identifier as an entry key into the cache.

15. The system of claim 11, wherein the first hit count is determined from a global counter for the first target population data set, and wherein the global counter is reset at a predetermined time.

16. The system of claim 11, wherein the first weight for the first target population data set is determined by combining the first hit count and the first size for the first target population data set.

17. The system of claim 16, wherein the first hit count and the first size are smoothed using a logarithmic function before the combining which comprises a sum.

18. The system of claim 16, wherein in response to the first hit count being over a threshold, the first hit count is set to a value of 1, and wherein in response to the first hit count being less than the threshold, the first hit count is set to a value of 0.

19. The system of claim 16, wherein the combined first hit count and the first size are rounded to a nearest integer.

20. A non-transitory computer-readable storage medium instructions which when executed by at least one processor causes operations comprising:
receiving a first identifier of a first target population data set;
checking, based on the first identifier, whether the first target population data set is stored in a cache;
in response to the first target population data set not being stored in the cache, determining a first size for the first target population data set, determining a first hit count for the first target population data set, and determining a first weight for the first target population data set,
wherein the first weight is calculated based at least on the first hit count and the first size for the first target population data set;
determining a second target population data set to evict from the cache to generate space to store the first target population data set, wherein the determining the second target population data set to evict is based at least on a second weight associated with the second target population data set;
evicting the second target population data set from the cache; and
storing the first target population data set in the cache.
